(19) United States
(12) Patent Application Publication
(10) Pub. No.: US 2026/0073202 A1
(43) Pub. Date: Mar. 12, 2026

(54) METHODS AND APPARATUS FOR SELF-SIMILAR COMPUTATION IN FIXED PRECISION SYSTEMS

(71) Applicant: Femtosense, Inc., San Bruno, CA (US)

(72) Inventor: Scott Henry Reid, San Francisco, CA (US)

(73) Assignee: Femtosense, Inc., San Bruno, CA (US)

(21) Appl. No.: 19/325,316

(22) Filed: Sep. 10, 2025

Related U.S. Application Data
(60) Provisional application No. 63/692,728, filed on Sep. 10, 2024.

(51) Int. Cl. G06N 3/0495; G06F 7/556

(52) U.S. Cl. CPC G06N 3/0495; G06F 7/556

(57) ABSTRACT

Methods and apparatus for accelerating self-similar computations. In one implementation, an input operand is divided into portions, and conditional shift logic determines a shift amount based on leading bits. A look-up table stores pre-computed values at reduced precision, and an arithmetic unit modifies the retrieved value based on the shift amount or remaining operand portion to generate a fixed precision result. The techniques reduce memory and computation requirements while preserving accuracy for operations such as logarithms, monomial expansions, and norm functions. Implementations may be applied to sensor preprocessing, audio and image compression, and neural network processing, enabling efficient handling of wide dynamic range data in embedded and low-power systems. The disclosed approaches provide scalable hardware and firmware architectures that reduce lookup table size, power consumption, and silicon area while supporting advanced signal and machine learning computations.

### PRIORITY APPLICATION

This application claims the benefit of priority to U.S. Provisional Patent Application Ser. No. 63/692,728 filed Sep. 10, 2024, and entitled “METHODS AND APPARATUS FOR SELF-SIMILAR COMPUTATION IN FIXED PRECISION SYSTEMS”, which is incorporated herein by reference in its entirety.

### RELATED APPLICATIONS

This application is related to U.S. patent application Ser. No. 17/367,512 filed Jul. 5, 2021, and entitled “METHODS AND APPARATUS FOR LOCALIZED PROCESSING WITHIN MULTICORE NEURAL NETWORKS”, U.S. patent application Ser. No. 17/367,517 filed Jul. 5, 2021, and entitled “METHODS AND APPARATUS FOR MATRIX AND VECTOR STORAGE AND OPERATIONS”, U.S. patent application Ser. No. 17/367,521 filed Jul. 5, 2021, and entitled “METHODS AND APPARATUS FOR THREAD-BASED SCHEDULING IN MULTICORE NEURAL NETWORKS”, U.S. patent application Ser. No. 18/049,453 filed Oct. 25, 2022, and entitled “METHODS AND APPARATUS FOR SYSTEM-ON-A-CHIP NEURAL NETWORK PROCESSING APPLICATIONS”, and U.S. patent application Ser. No. 18/586,891 filed Feb. 26, 2026, and entitled “METHODS AND APPARATUS FOR ACCELERATING TRANSFORMS VIA SPARSE MATRIX OPERATIONS”, each of which are incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of processor acceleration. More particularly, the present disclosure is directed to hardware, software, and/or firmware implementations of certain types of algorithms.

### DESCRIPTION OF RELATED TECHNOLOGY

Unlike traditional computer architectures, neural network processing emulates a network of connected nodes (also referred to throughout as “neurons”) that loosely model the neuro-biological functionality found in the human brain. Incipient research is directed to “neural network” solutions for embedded applications; embedded applications are heavily resource constrained (e.g., processing capability, memory space, network connectivity, and/or power consumption).

As a separate tangent, real-world sensors often must span a very large dynamic range. For example, shouting and whispering occur in very different decibel ranges. Similarly, sunlight and shadows have large differences in light intensity. Unfortunately, the large dynamic range of real-world sensor data introduces significant hurdles for embedded neural network processing.

### BRIEF DESCRIPTION OF THE DRAWINGS

FIG. 1 depicts a LUT-based fixed precision implementation of a logarithm function.

FIG. 2 depicts a fixed precision logic for accelerating logarithm operations for vector processing, in accordance with various aspects of the present disclosure.

FIG. 3 depicts a fixed precision logic for accelerating monomial operations for vector processing, in accordance with various aspects of the present disclosure.

FIG. 4 is a logical block diagram of one apparatus, useful in accordance with the various principles described herein.

FIG. 5 is a logical block diagram of a method for self-similar computation in fixed precision systems, useful in accordance with the various principles described herein.

FIG. 6 is a logical block diagram of one apparatus, useful in accordance with the various principles described herein.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

### Fixed Precision Computation

“Fixed precision” (also referred to as “fixed point”) processors are commonly found in embedded devices and other applications where industrial constraints prohibit more computationally complex alternatives (e.g., floating point processors, etc.). Fixed precision processors have a first number of bits reserved for an integer portion and a second number of bits reserved for the fractional portion. Thus, for example, an 8-bit fixed precision processor might represent a number as 4-bits of integer and 4-bits of fraction (e.g., 1111.1111_b=15.9425_d). Fixed precision may be signed or unsigned; e.g., an 8-bit integer may represent unsigned integers 0-255 or signed integers −128-127). Fixed precision processors are usually limited to arithmetic and logical operations on integer data.

Fixed precision processors often include basic arithmetic operations for addition, subtraction; they may also include multiplication, division, and modulo—however the fixed bitwidth presents significant issues. For example, multiplying two unsigned 8-bit numbers requires 16-bits to represent the full range of products (0-65025). In some cases, the product may be represented with an 8-bit MSB (most significant bits) and 8-bit LSB (least significant bits). Alternatively, numerical truncation and/or overflow/underflow logic (where necessary) may be used to fit the data within the designated bitwidth.

Truncation errors compound with more sophisticated operations (e.g., exponents, logarithms, etc.) and/or techniques (e.g., Taylor series expansion, etc.). Thus, most fixed precision processors handle these types of operations with look-up tables (LUTs), rather than direct computation. LUTs “compute” results by retrieving pre-computed values from a memory; i.e., input value(s) are used to index output values. The size of a LUT is given by its addressable range and data bitwidth; unfortunately, LUTs exponentially scale with address range. For example, an 8-bit address with 16-bit outputs would be 4096 bits, but a 16-bit address for 16-bit outputs would be 1,048,576 bits.

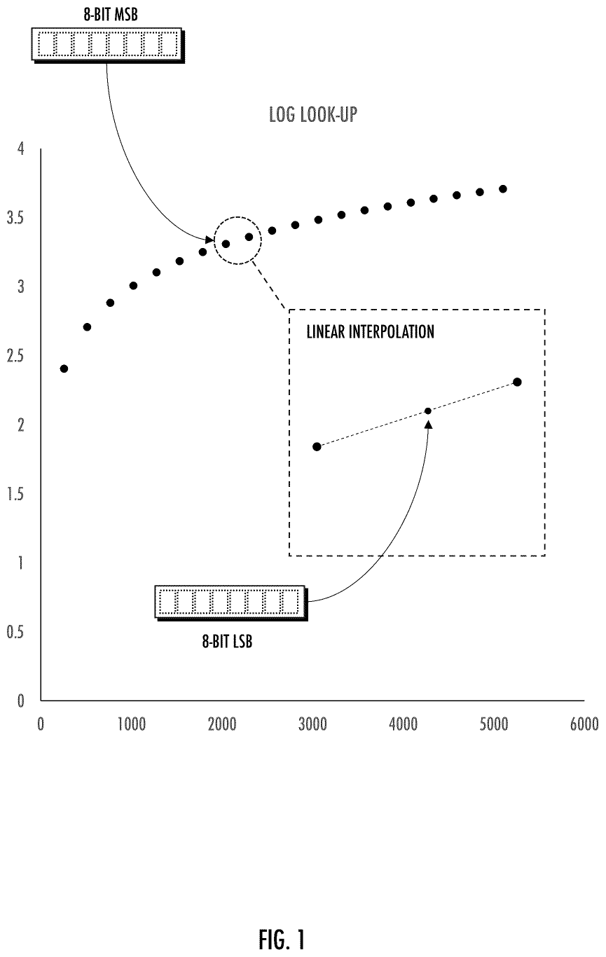

LUTs are often paired with approximation techniques such as interpolation to balance accuracy against memory limitations. Consider a LUT-based fixed precision implementation of a logarithm function, which is graphically represented in FIG. 1. The algorithm splits the 16-bit input (here, an unsigned integer) into an 8-bit MSB and an 8-bit LSB. The 8-bit MSB is used to index a LUT for a gross approximation of the log. The 8-bit LSB is used to linearly interpolate to the final result. Conventional architectures may trade-off different splits to achieve different levels of accuracy and/or resource utilization; e.g., a 12-bit MSB has a significantly larger LUT, that narrows the linear approximation window, etc.

As a practical matter, fixed precision processing ensures a consistent number of bits for representing numbers, which simplifies the hardware design and reduces the computational overhead. Unlike floating point processing, which handles a wide range of values with varying precision, fixed precision processing imposes limitations on the range and precision of values, making it suitable for applications with known and bounded numerical requirements. This is necessary to minimize errors related to rounding and provide more predictable behavior. Applications that use fixed precision processing typically prioritize speed, predictability, and resource efficiency. These characteristics are often found in embedded systems, real-time computing environments, and certain signal processing tasks where consistent performance and low power consumption are critical. Large variances in data are generally assumed to be rare, or where it justifies the additional cost, may be more readily offloaded to floating point logic.

Techniques for Self-Similar Computation within Fixed Precision

Femtosense, Inc. designs sparse processing units (SPUs) for neural network computing. Neural network computing scales with network complexity (roughly quadratically), thus large networks typically require substantial resources. Furthermore, most solutions focus on large fractional network weightings—which requires floating point operation. In contrast, the Femtosense SPU is focused on enabling large neural networks at very low power, by leveraging network sparsity. The Femtosense SPU is also able to perform such operations with fixed precision, further improving speed, performance, and power consumption. In other words, the Femtosense SPU represents a significant departure from conventional solutions for neural network computing. As a result, the Femtosense SPU enables new opportunities and use cases for very low power embedded applications (e.g., battery operated, etc.) that require complex networks.

Fixed precision neural networks require that inputs be within a linearly quantized range (this is significantly less important for floating point neural networks which represent values with a mantissa and exponent). Unfortunately, most real-world sensor data is non-linear (e.g., exponential, etc.) in nature, and is difficult to measure linearly. For example, sound is measured according to the decibel (dB) scale which is log-based. The typical human ear can just barely detect audio at ˜0 dB, a whisper is ˜30 dB, a private conversation is ˜60 dB, a lawn mower is ˜90 dB, a jet engine is ˜120 dB. Similarly, light is typically characterized by “lux”; lux is not log-based, however ambient light levels demonstrate exponential behavior on a linear scale e.g., a full moon provides ˜1 lux, twilight is ˜10 lux, a dark day is ˜100 lux, an overcast day ˜1000 lux, full daylight ˜10,000 lux, and a very bright summer day ˜100,000 lux.

Furthermore, training a fixed precision neural network to recognize speech or images without pre-processing the input would require much larger bit widths and training over different scales, resulting in immense models. Similarly, dedicated floating point pre-processing to convert real-world input to fixed precision takes substantial silicon (expensive to manufacture) and introduces additional processing, glue logic, and other overhead. Either of these techniques might obviate much or all of the benefit from fixed precision processing, thus new techniques are needed.

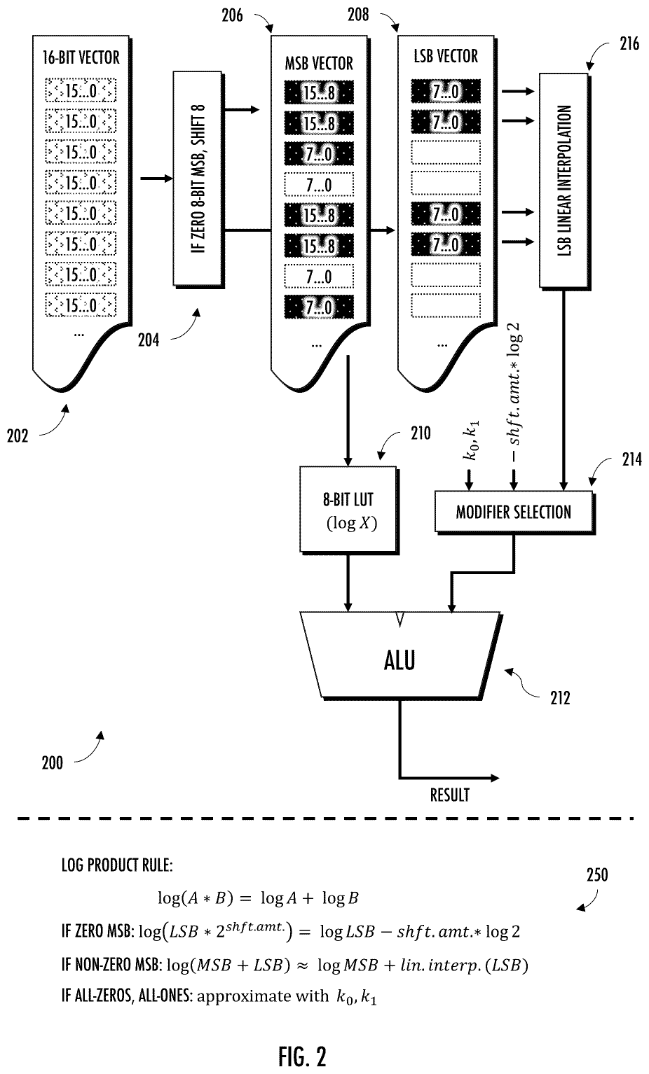

Consider the illustrated example 200 of FIG. 2, which depicts fixed precision logic that accelerates logarithmic operations for vector processing. The fixed precision logic may be incorporated within a fixed precision processor. Alternatively, the fixed precision logic may be implemented as dedicated logic in a pre-processing/post-processing stage.

As shown, the fixed precision logic obtains an input vector 202 with fixed precision elements (e.g., audio samples, image samples, etc.). In the illustrated embodiment, the elements are 16-bit samples—depending on sensor capabilities, the input samples may be within the sensor's operating range (e.g., non-zero data) or could be outside the sensing range (e.g., all-zeros or all-ones). In some implementations, the elements of the input vector may additionally be flagged for special handling of all-zeros and/or all-ones (e.g., using an additional flag bit(s), etc.).

Conditional shift logic 204 shifts elements of the input vector based on their contents. Here, the conditional shift logic 204 determines whether the 8 most significant bits (8-bit MSB) are all-zero; if so, then the 8 least significant bits (8-bit LSB) are shifted by 8-bits into the 8-bit MSB position and the LSB are zero-padded. Otherwise, if the 8-bit MSB are non-zero, then both 8-bit MSB and 8-bit LSB remain untouched. In some variants, the shifted 8-bit LSB (now, in 8-bit MSB position) are checked for all-zeros.

The conditional shift logic 204 shifts by a fixed amount (e.g., 8-bits), however, other implementations may shift by different amounts (e.g., 1-bit, 2-bits, 4-bits, 16-bits, etc.). Additionally, some implementations may determine how many bits to shift for each element—for example, an element with 2 leading zeros may be shifted by 2, an element with 3 leading zeros may be shifted by 3, etc. In some cases, shifts may be performed in increments (e.g., shift increments of 2-bits, 4-bits, 16-bits, etc.); e.g., an element with 3 leading zeros might be shifted by a 2-bit increment (leaving one leading zero). The shift amount may be stored (via a register, register array, etc.) to calculate a modifier (as described in greater detail below).

Here, the 16-bit input vector is split into a first sub-vector 206 that contains the conditionally shifted 8-bit MSBs (either the original MSBs and/or at least some portion of the shifted LSBs) and a second sub-vector 208 that contains the conditionally shifted 8-bit LSBs (some portion of the original LSBs and/or zero padding). While the illustrated example of FIG. 2 depicts a 16-bit vector being split into two 8-bit sub-vectors, any numerosity and/or dimensionality may be substituted with equal success. For example, a 16-bit input vector might be split into four 4-bit sub-vectors, a 32-bit input vector might be split into two 16-bit sub-vectors, etc.

The elements of the first sub-vector 206 are used to reference a look-up table (LUT 210) for a first term of an ALU 212 (arithmetic logic unit). In this case, the LUT 210 is populated with data for logarithm (e.g., an 8-bit LUT for log X). As previously alluded to, LUT size scales exponentially as a function of address range, thus an 8-bit LUT is significantly smaller than a 16-bit equivalent (˜4 kb versus ˜1 Mb)—this represents a substantial reduction in memory footprint.

Modifier selection logic 214 selects the second term for the ALU 212. Modifier selection logic for the illustrated embodiment is elaborated within breakout 250 and performed on an element-wise basis.

If the original MSBs of the 16-bit element were all zeros, then the appropriate modifier is based on the conditional shift amount. Conceptually, a bit shift by shft.amt. is a multiplication by 2^{shft.amt.}; thus, the fixed precision logic can leverage the log product rule (e.g., log(A*B)=log A+log B) to add and subtract the bit shift correction. In other words, the conditionally shifted 8-bit MSBs are first used to look-up an estimate of the log from the LUT 210. Then, the shift amount is used to calculate the correction term shft.amt.*log 2 (e.g., an 8-bit shift=8*log 2). The result is calculated by subtracting the correction from the log estimate.

If the original MSBs of the 16-bit element were non-zero, then the appropriate modifier may be approximated. The illustrated example uses a linear interpolation block 216. Specifically, the original 8-bit MSBs are first used to look-up a lower estimate (original 8-bit MSB) and an upper estimate (original 8-bit MSB+1) of the log from the LUT 210. The difference between the upper estimate and the lower estimate may be fractionally apportioned based on the original 8-bit LSB—a non-zero bit 7 corresponds to a W of the difference value, a non-zero bit 6 corresponds to ¼ of the difference value, etc. The sum of all fractional components is the linearly interpolated correction value. The result is calculated by adding the linearly interpolated correction value to the lower estimate. Other forms of approximation may be substituted with equal success.

If the original input element is all zeros or all ones, then the input element is outside the fixed precision range (and also, typically, outside of the sensor's capabilities). Constants k₀, k₁ may be used to represent these out-of-bounds values—these values may be selected to ensure that downstream processing receives in-bound defined values (notably log(0) is undefined). In some cases, flags may be used to convey data overflow/underflow.

Logarithms and their related properties are commonly used for compressing real world data. Examples include e.g., log-mel transforms for audio and image signal processing (ISP) for image and video data. However, these concepts may also be extended to other types of “self-similar” computation. As but one example, monomial expansion is used for calculating reciprocals, square roots, power functions, as well as non-linear functions (e.g., tanh and sigmoid). Notably, tanh and sigmoid functions are commonly used internally within neural network computations to represent error; error calculations are often numerically small (require large amounts of precision to correctly represent) and related to the derivative. Similarly, neural network computing may make extensive use of norm functions (layer norm, batch norm, instance norm, etc.); these operations are often decomposed into sub-operations (e.g., (X/Y)^{N}=X^{N}*(1/Y)^{N}) and/or may make extensive usage of specific operations (e.g., 1/\sqrt{X}, etc.)

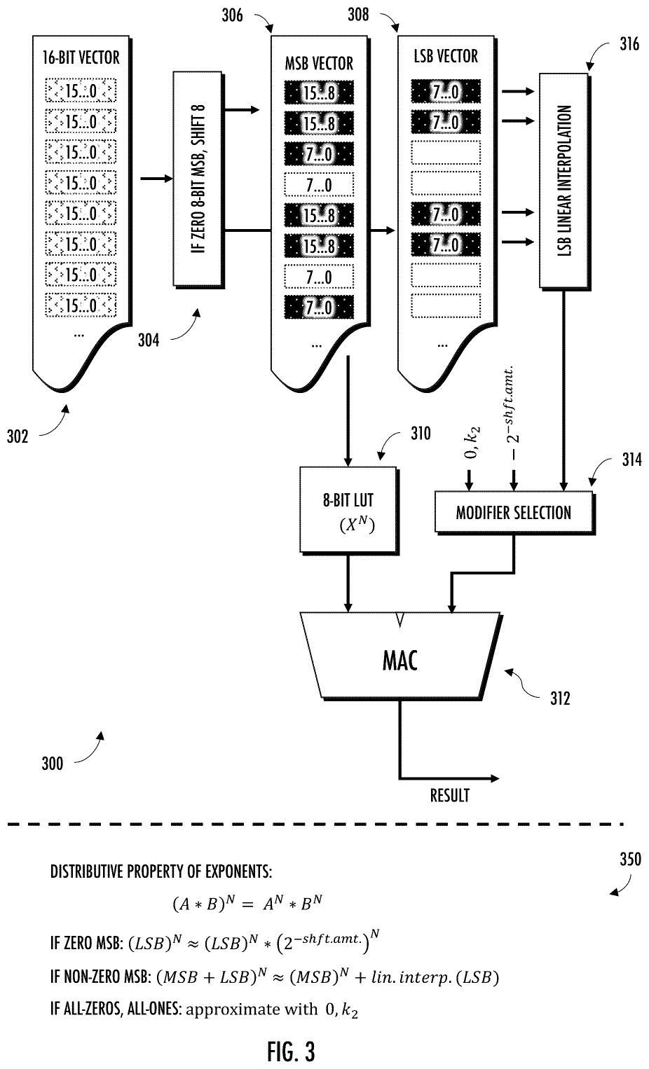

Referring now to FIG. 3, fixed precision logic 300 for accelerating monomial operations for vector processing is shown. The fixed precision logic of FIG. 3 has many structural similarities to the fixed precision logic of FIG. 2 and may be implemented within the same physical logic and/or hybrid dual-purpose logic. Alternatively, they may be implemented via separate dedicated logic for other stages of a processing pipeline, etc.

Much like the example above, the fixed precision logic obtains an input vector 302 with fixed precision elements. As previously noted, the illustrated elements are 16-bit samples—but the concepts may be extended to any bit width (e.g., 8-bit, 10-bit, 12-bit, 32-bit, 64-bit, etc.). In addition, some variants may flag elements of the input vector as being all-ones or all-zeros.

Conditional shift logic 304 shifts elements of the input vector based on their contents. Here, the conditional shift logic 304 determines whether the 8 most significant bits (8-bit MSB) are all-zero; if so, then the 8 least significant bits (8-bit LSB) are shifted by 8-bits into the 8-bit MSB position and the LSB are zero-padded. Otherwise, if the 8-bit MSB are non-zero, then both 8-bit MSB and 8-bit LSB remain untouched. In some variants, the shifted 8-bit LSB (now, in 8-bit MSB position) are checked for all-zeros. Shifts may be made by a fixed amount, a determined amount, and/or increments.

The input vector may be split into a first sub-vector 306 that contains the conditionally shifted 8-bit MSBs and a second sub-vector 308 that contains the conditionally shifted 8-bit LSBs. Any numerosity and/or dimensionality may be substituted with equal success. Here, the elements of the first sub-vector 306 are used to reference a look-up table (LUT 310) for a first term of a MAC 312 (multiply-accumulate) operation. In this case, the LUT 310 is populated with data for a monomial expansion (e.g., an 8-bit LUT for X^{N}). Depending on physical implementation, the MAC 312 may be combined within an ALU (e.g., commonly found in general purpose central processing units (CPUs)) and/or separate dedicated logic (e.g., commonly found in digital signal processors (DSPs)).

Modifier selection logic 314 selects the second term for the MAC 312. Modifier selection logic for the illustrated embodiment is elaborated within breakout 350 and performed on an element-wise basis. As shown in FIG. 3, monomial expansion uses the distributive property of exponents (e.g., (A*B)^{N}=A^{N}*B^{N}) to scale fixed precision operations. Here, if the original MSBs of the 16-bit element were all zeros, then the appropriate modifier is based on the conditional shift amount. The conditionally shifted 8-bit MSBs (previously LSBs) are first used to look-up an estimate of the product from the LUT 310. Then, the shift amount is used to calculate the correction term (2^{-shft.amt.})^{N} (e.g., an 8-bit shift=(2⁻⁸)^{N}). The product is calculated by multiplying the correction from the product estimate.

If the original MSBs of the 16-bit element were non-zero, then the appropriate modifier may be approximated. The illustrated example uses a linear interpolation block 316. Specifically, the original 8-bit MSBs are first used to look-up a lower estimate (original 8-bit MSB) and an upper estimate (original 8-bit MSB+1) of the product from the LUT 310. The difference between the upper estimate and the lower estimate may be fractionally apportioned based on the original 8-bit LSB. The result may be calculated by adding the linearly interpolated correction value to the lower estimate. Other forms of approximation may be substituted with equal success.

The product of anything with 0 is 0, so if the original input element is all-zero the product is zero. If the original input element is all ones, then the input element is outside the fixed precision range constant k₂ may be used to represent an out-of-bounds value. In some cases, flags may be used to convey data overflow/underflow (e.g., with an additional flag bit(s), etc.).

While the foregoing examples incorporate linear interpolation, artisans of ordinary skill in the related arts will readily appreciate that linear interpolation (or any other approximation technique) may also be skipped. In other words, additional approximation steps may be optionally performed and/or may be employed in some operations but not others. For example, certain operations may not require accuracy to the same level of precision, etc.

### System Architecture

Various embodiments of the present disclosure accelerate self-similar computations within fixed precision systems. As used herein, an operation is self-similar if an arithmetic property exists between different scales. A linear scale has constant increments; a logarithmic scale has logarithmic increments, an exponential scale has exponential increments, etc. In other words, a self-similar computation refers to an arithmetic operation that preserves proportional or recursive structure and/or relationships/properties across multiple numerical scales. Such operations can be decomposed into smaller sub-computations at reduced precision and subsequently recombined to yield an equivalent result at higher precision. As previously noted, examples may include logarithmic functions (e.g., log product rule) and monomial expansions (e.g., distributive property of exponents). These relationships allow computations to be partitioned into smaller, fixed-precision components. By exploiting self-similar properties, the disclosed techniques enable large dynamic range operations to be performed with reduced look-up table size and lower silicon cost, while avoiding overflow and underflow errors common in fixed-precision systems.

While the foregoing examples are presented in the context of a specific split and numerosity (16 bit word into two 8 bit words), self-similar computations may be decomposed into sub-computations which can be performed in different scales (at any numerosity, size, etc.) at fixed precision; once the sub-computations are complete, they can be recomposed to determine the final result within the same fixed precision. In other words, rather than performing the complete computation to complete precision, the sub-computations allow for portions of the computation to be handled within precision limits. In some cases, the sub-computations may also substitute approximation techniques to remain within precision limits. These concepts may be broadly extended to other precision limited applications and are broadly applicable to any numeric base (e.g., base 2 (binary), base 8 (octal), base 10 (decimal), base 16 (hexadecimal), etc.).

Different scales may enable re-use of specialized software and/or hardware. While the foregoing examples are presented in the context of a look-up-table (LUT) to retrieve results, any logic and/or memory may be substituted with equal success. For example, some implementations may use direct calculation or estimation (e.g., via Taylor series expansion, etc.) or some hybrid of calculation, estimation, and/or look-up. Furthermore, while the foregoing discussion uses a linear approximation, other implementations may substitute other types of approximations or even entirely forego approximation altogether.

The concepts described throughout may have broad applicability to multiple different stages of a processing pipeline. Some stages of a pipeline may be tasked with converting sensor data into processor data (e.g., converting waveforms into data packets using log-mel, etc.). Other stages of a pipeline may be tasked data manipulations of processor data (e.g., neural network processing using layer norm, batch norm, etc.). Still other stages of a pipeline may be tasked with system control and management (e.g., general processing and/or data presentation).

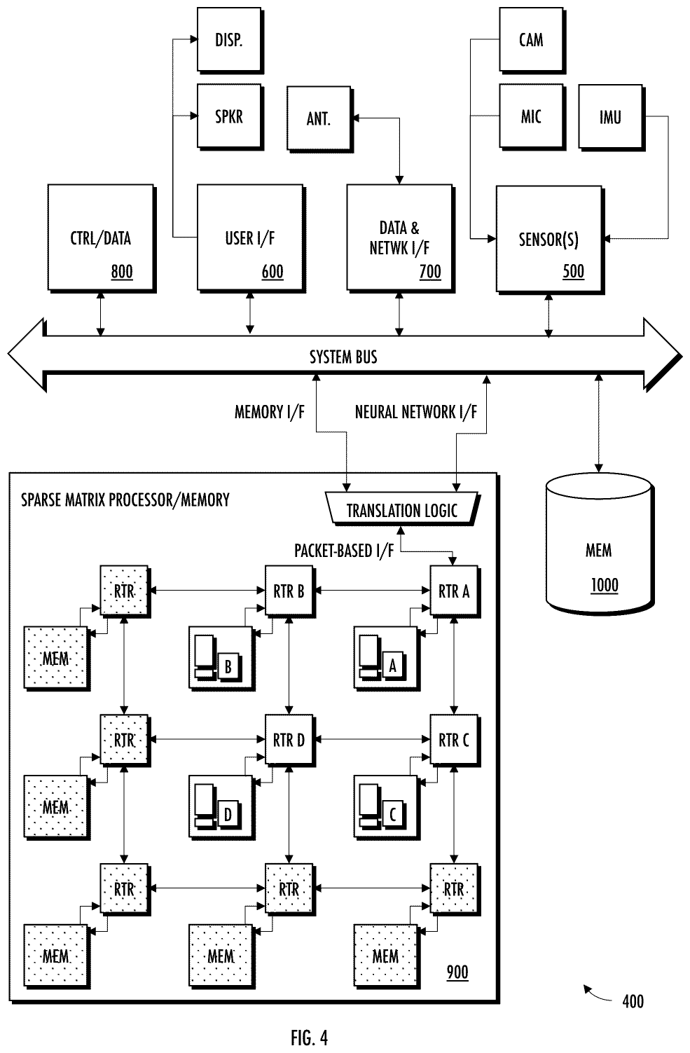

FIG. 4 is a logical block diagram of one generalized apparatus, useful in accordance with the various principles described herein. The apparatus may be functionally divided into: a sensor subsystem 500, a user interface subsystem 600, a data/network interface subsystem 700, a control and data subsystem 800, and a bus to enable data transfer. In one specific implementation, the control and data subsystem additionally includes a machine learning subsystem which may include a sparse matrix processor and/or memory.

The following discussion provides a specific discussion of the internal operations, design considerations, and/or alternatives, for each subsystem of the generalized apparatus 400.

Referring first to the sensor subsystem 500, Functionally, sensors sense the physical environment and captures and/or records the sensed environment as data. The illustrated sensor subsystem includes: a camera sensor, a microphone, and an inertial measurement unit (accelerometer, gyroscope, magnetometer).

A camera lens bends (distorts) light to focus on the camera sensor. The camera sensor senses light (luminance) via photoelectric sensors (e.g., CMOS sensors). Typically, a color filter array (CFA) value provides a color (chrominance) that is associated with each sensor. The combination of each luminance and chrominance value provides a mosaic of discrete red, green, blue value/positions, that may be “demosaiced” to recover a numeric tuple (RGB, CMYK, YUV, YCrCb, etc.) for each pixel of an image.

An image is a digital representation of sensed light. Image data may refer to the raw image information (e.g., physical photosite values and chrominance information) or the demosaiced pixels. Pixel data is usually formatted as a two-dimensional array whereas raw image information may be physically irregular (corresponding to the physical photosite sizes and layouts).

A video is a sequence of images over time that conveys image motion. The individual images are also referred to as “frames”; frames are taken at specific moments in time (according to a frame interval or frame rate).

A “codec” refers to the hardware and/or software mechanisms for “encoding” and “decoding” media. A significant portion of codec processing is based on signal processing transforms such as the Discrete Cosine Transform (DCT). For example, most MPEG standards subdivide an image into 8 pixel by 8 pixel (8×8) blocks and/or macroblocks (16×16). The blocks are then transformed using a 2-dimensional DCT to obtain their (cosine) frequency components. The transformed image data can use correlation between adjacent image pixels to provide energy compaction or coding gain in the frequency-domain.

Additionally, due to the large amount of redundant information, most video frames may refer to information from other video frames. For example, so called “I-frames” are “intracoded” which means they contain a complete set of information to reproduce the frame. In contrast, “P-frames” are predicted from other frames (e.g., I-frames, P-frames, or B-frames); “B-frames” are bi-directionally predicted—e.g., they may reference information from frames that occur before or after the instant frame.

Within the context of the present disclosure, logarithm-based compression/decompression techniques are commonly used within image/video codecs to encode luminance and/or other aspects of light intensity. For example, high dynamic range (HDR) images commonly encode luminance with multiple orders of magnitude of difference. Similarly, certain types of image signal processing may benefit from optimized logarithms. So-called homomorphic filtering uses log-based operations in Fourier space to perform image enhancement modifying the effects of illumination and reflectance.

While present disclosure is described in the context of perceptible light, the techniques may be applied to other EM radiation capture and focus apparatus including without limitation: infrared, ultraviolet, and/or X-ray, etc.

A microphone senses acoustic vibrations and converts the vibrations to an electrical signal (via a transducer, condenser, etc.) Typically, additional filtering and noise reduction may be performed to compensate for microphone characteristics. The resulting audio waveform may be compressed for delivery via any number of audio data formats. Audio data formats often rely on the Discrete Fourier Transform (DFT), Fast Fourier Transform (FFT), and/or other spectral transforms.

Microphones have a wide array of physical configurations. While the foregoing techniques are described in the context of a single microphone, multiple microphones may be used to collect stereo sound and/or enable audio processing. For example, any number of individual microphones can be used to constructively and/or destructively combine acoustic waves (also referred to as beamforming). Furthermore, different microphone structures may have different acoustic characteristics; for example, boom and/or shotgun-style microphones have different characteristics than omnidirectional microphones.

Within the context of the present disclosure, logarithm-based compression/decompression techniques are commonly used within audio codecs to encode audio with different properties e.g., log-mel and other log-compressed transforms, etc. Similarly, cepstral and mel-cepstral transformations may leverage logarithms between FFT and IFFT transformations; these transformations may be used to identify and/or remove the effects of echoes, reflections, etc. and/or other speech artifacts.

While present disclosure is described in the context of perceptible sound, the techniques may be applied to other acoustic capture and focus apparatus including without limitation: seismic, ultrasound, etc.

The inertial measurement unit (IMU) includes one or more accelerometers, gyroscopes, and/or magnetometers. These measurements may be mathematically converted into a four-dimensional (4D) quaternion to describe motion.

Typically, an accelerometer uses a clamped mass and spring assembly to measure proper acceleration (acceleration in its own instantaneous rest frame). In many cases, accelerometers may have a variable frequency response. Most gyroscopes use a rotating mass to measure angular velocity; a MEMS (microelectromechanical) gyroscope may use a pendulum mass to achieve a similar effect by measuring the pendulum's perturbations. Most magnetometers use a ferromagnetic element to measure the vector and strength of a magnetic field; other magnetometers may rely on induced currents and/or pickup coils. The IMU uses the acceleration, angular velocity, and/or magnetic information to calculate quaternions that define the relative motion of an object in four-dimensional (4D) space. Quaternions can be efficiently computed to determine velocity (both device direction and speed).

While present disclosure is described in the context of quaternion vectors, artisans of ordinary skill in the related arts will readily appreciate that raw data (acceleration, rotation, magnetic field) and any of their derivatives may be substituted with equal success.

Furthermore, while the foregoing discussion is presented in the context of a specific set of sensors, any sensor or sensing technique may be substituted with equal success. Additionally, other sensor subsystem implementations may multiply, combine, further sub-divide, augment, and/or subsume the foregoing functionalities within these or other subsystems. For example, microphones may be used in conjunction with the user interface subsystem to enable voice commands. Similarly, an infrared transmitter/receiver of the data/network interface subsystem may also be used to e.g., sense heat, etc.

In the context of the present disclosure, physically sensed data may need to be processed before being used in subsequent stages of processing (pre-processed). This may entail analog as well as digital variance e.g., automatic gain control (AGC), automatic frequency control (AFC), re-sampling, normalization, and any other common data formatting. As previously noted, a sensor may be able to capture data across many different bit widths (e.g., 8-bit, 10-bit, 12-bit, etc.) but downstream processing may have a single supported bit width. In some cases, sensor data may be converted from a first scale to a second scale (e.g., linear-to-log, log-to-linear, etc.). Similarly, certain types of pre-processing may be used to filter information in view of the end-application (e.g., human vision, computer vision, etc.). For instance, the human eye can perceive red in bright light, but in low light conditions blue and green light dominate the spectral response; the human ear has certain pitches which are attenuated/amplified, etc. Machine data may be translated to compensate for differences to correctly represent colors or render sounds the way that a human would perceive them, etc. (e.g., REC. 709, REC. 2020, Mel transform, log-Mel transform, etc.).

Sensed data may be stored in array-based data structures, based on their modality of capture. For example, a 1-dimensional waveform like acoustic data might be represented as a vector, a 2-dimensional image might be represented as a matrix, etc. Multiple sensors of the same modality may be provided as different tracks of data structures (e.g., stereo audio, dual camera feeds, etc.). Sensor data may be sampled according to a periodic sampling frequency or asynchronously timestamped. In some cases, sensor data may have higher order dimensionality (e.g., 3D mappings, heat charts, etc.). Depending on implementation, data structures may be vectors, vectors of vectors, matrices, linked lists, and/or any other form of array-based data.

Various embodiments of the present disclosure enable new forms of sensor-based pre-processing. Specifically, the techniques described throughout enable array-based sub-computations that leverage self-similar properties for pre-processing of sensor data. In one embodiment, sensed data in array-based data structures are decomposed into sub-computations for pre-processing. For example, linear acoustic data may be pre-processed to generate a log-mel data for downstream noise reduction processing. An element-wise conditional shift may be used to ensure that all the elements of the array-based data structure are within the appropriate scale of a LUT-based look-up for a first sub-computation. A second array records the conditional shift correction for a second sub-computation. Other forms of pre-processing may be readily substituted with equal success, given the contents of the present disclosure.

Handling the pre-processing in sub-computations may yield multiple benefits in terms of processing complexity, array size, memory space, etc. for the pre-processing operation. In some cases, this pre-processing logic may be incorporated within the sensor components themselves (prior to system bus interconnection which can greatly reduce bus power consumption and/or bus traffic and overhead). More generally, these techniques broadly enable pre-processing of sensor data in embedded, firmware, and/or other resource constrained logic.

Furthermore, the techniques described throughout may also reduce resource requirements for sensor integration with subsequent processing stages. For example, these techniques may have synergistic results when combined with reduced system bit width and/or fixed precision processing downstream (with all their attendant benefits). For example, many self-similar computations have compressive qualities. An input signal with 96 dB of dynamic range requires 16-bit integer inputs to cover the full range. Log compression may enable lower-precision integers to compress the original signal (e.g., 8-bit instead of 16-bit, etc.).

Direct access implementations of the sensor subsystem 500 may operate in parallel with, or independent from, multiple components of the control and data subsystem 800. As but one such example, a machine learning subsystem may directly read audio/visual data from the sensor subsystem 500, without e.g., an image signal processor (ISP), digital signal processor (DSP), graphics processing unit (GPU), and/or central processing unit (CPU), etc. In some embodiments, this may enable machine-specific applications that do not interfere with user experience or may even augment ongoing user applications—e.g., voice recognition may run in the background while the user is also using the microphone for other tasks, etc. In other embodiments, this may enable very low-power operations (e.g., without requiring booting a high-level operating system, etc.).

Functionally, the user interface subsystem 600 presents media to, and/or receives input from, a human user. In this example the user interface subsystem 600 may include visual aspects (a GUI and in some cases image capture, etc.), acoustic aspects (sound playback and capture, etc.), and/or manual input (key presses, etc.).

In some embodiments, media may include audible, visual, and/or haptic content. Examples include images, videos, sounds, and/or vibration. Visual content may be displayed on a screen or touchscreen. Sounds and/or audio may be obtained from/presented to the user via a microphone and speaker assembly. Additionally, rumble boxes and/or other vibration media may playback haptic signaling. Here, the illustrated user interface subsystem includes a display, microphone and speakers. While not shown, input may also be interpreted from touchscreen gestures, button presses, device motion, and/or commands (verbally spoken). The user interface subsystem may include physical components (e.g., buttons, keyboards, switches, scroll wheels, etc.) or virtualized components (via a touchscreen).

A display presents images and/or video to a user. The display renders an array of pixels, each pixel having a corresponding luminance and color. Displays also periodically refresh the image data at a specified refresh rate; the refresh rate enables both video (moving images) and static image displays. As previously alluded to, image data is generally too large to be stored and/or transmitted in this format. Instead, the image data is encoded and compressed for storage/transfer, and then decoded and decompressed for presentation.

The decoding and decompression process inverts (reverses) the process of encoding and compression. Thus, for example, video that has been encoded with the Discrete Cosine Transform (DCT) uses an Inverse DCT (IDCT). In other words, most MPEG standards reconstruct image blocks/macroblocks from the DCT frequency coefficients.

A speaker reproduces acoustic sound for a user. Typically, an audio driver converts encoded audio media into frequency information that is used to generate electrical waveforms. The waveforms are amplified and converted into mechanical motion drive a speaker at the desired frequencies. The resulting vibrations compress air to create acoustic waves that can be heard by the human ear. Much like video codecs, audio codecs rely on Inverse FFT (IFFT) and/or Inverse DFT (IDFT) to generate the resulting waveforms.

Self-similar computations may enable and/or improve a variety of user interface (UI) processing within fixed precision processing. For example, audio processing may enable voice commands, etc. and/or image processing may enable hand gestures, eye-tracking, etc. in embedded applications. Still other improvements are readily appreciated by those of ordinary skill in the related arts given the contents of the present disclosure.

Various embodiments of the control and data subsystem 800 may provide media data to the user interface subsystem 600 for presentation. For example, the central processing unit (CPU) may obtain manual input from a user, a graphics processing unit (GPU) may be used to display a GUI, a digital signal processor (DSP) may be used to record and/or render audio. In some cases, a machine learning subsystem may perform signal processing to assist in user interface tasks. Such concepts are more thoroughly explored within U.S. patent application Ser. No. 18/586,891 filed Feb. 26, 2024, and entitled “METHODS AND APPARATUS FOR ACCELERATING TRANSFORMS VIA SPARSE MATRIX OPERATIONS”, previously incorporated by reference in its entirety.

Functionally, the data/network interface subsystem 700 transmits and/or receives data to other machines. Here, the data and network interface subsystem includes radio(s), modem(s), and antenna(s). Other implementations may include wired interfaces and/or removeable media interfaces (e.g., SD cards, Flash Drives, etc.).

As a brief aside, radio(s), modem(s), and antenna(s) are often used to provide wireless connectivity. Wi-Fi and cellular modems are often used for communication over long distances. Many embedded devices use Bluetooth Low Energy (BLE), Internet of Things (IoT), ZigBee, LoRa WAN (Long Range Wide Area Network), NB-IoT (Narrow Band IoT), and/or RFID type interfaces. Still other network connectivity solutions may be substituted with equal success, by artisans of ordinary skill given the contents of the present disclosure.

Many modern wireless modems are heavily based on signal processing techniques. For example, Orthogonal Frequency Division Multiple Access (OFDMA) is a multiple access technique used in wireless communication systems, particularly in the context of modern cellular networks like LTE (Long-Term Evolution) and 5G. In OFDMA, the available spectrum is divided into multiple subcarriers which change across time slots (time-frequency resources).

In the forward link, the base station assigns data symbols for each user to frequency subcarriers; the set of data symbols are modulated (DFT) into waveforms which are then transmitted as a radio frequency (RF) signal for each time slot. Each user receives the RF signal and demodulates the signal (IDFT). In addition to the physical air interface, a variety of other codecs and/or signal processing may also be used for signal processing of the data symbols. For example, encryption and encoding ensure that each user may only recover their own data symbols.

In the reverse link, the user device may modulate and transmit information to the base station using single carrier frequency division multiple access (SC-FDMA)—which generates the subcarriers for just the user's allocated transmit resources. The base station receives the aggregate user symbols and performs the corresponding demodulation (IDFT) to recover each user's transmitted symbols.

While present disclosure is described in the context of OFDMA, IDFTs, DFTs, and SC-FDMA, the techniques may be applied to other radio interfaces with equal success.

Network connectivity may be used to enable a variety of unique applications. For example, a device may receive information from remote sensors (such as a distributed microphone array) and/or provide information to remote transducers (such as a stereo speaker, or earbuds). Network connectivity may also be used to coordinate operations as well as divide/combine processing loads across devices.

The following discussion provides a specific discussion of the internal operations, design considerations, and/or alternatives, for the control and data subsystem 800. Processors execute a set of instructions to manipulate data and/or control a device. Artisans of ordinary skill in the related arts will readily appreciate that the techniques described throughout are not limited to the basic processor architecture and that more complex processor architectures may be substituted with equal success. Different processor architectures may be characterized by e.g., pipeline depths, parallel processing, execution logic, multi-cycle execution, and/or power management, etc.

Typically, a processor executes instructions according to a clock. During each clock cycle, instructions propagate through a “pipeline” of processing stages; for example, a basic processor architecture might have: an instruction fetch (IF), an instruction decode (ID), an operation execution (EX), a memory access (ME), and a write back (WB). During the instruction fetch stage, an instruction is fetched from the instruction memory based on a program counter. The fetched instruction may be provided to the instruction decode stage, where a control unit determines the input and output data structures and the operations to be performed. In some cases, the result of the operation may be written to a data memory and/or written back to the registers or program counter. Certain instructions may create a non-sequential access which requires the pipeline to flush earlier stages that have been queued, but not yet executed. Exemplary processor designs are also discussed within U.S. patent application Ser. No. 17/367,517 filed Jul. 5, 2021, and entitled “METHODS AND APPARATUS FOR MATRIX AND VECTOR STORAGE AND OPERATIONS”, and U.S. patent application Ser. No. 17/367,521 filed Jul. 5, 2021, and entitled “METHODS AND APPARATUS FOR THREAD-BASED SCHEDULING IN MULTICORE NEURAL NETWORKS”, previously incorporated by reference in their entireties.

As a practical matter, different processor architectures attempt to optimize their designs for their most common usages. More specialized logic can often result in much higher performance (e.g., by avoiding unnecessary operations, memory accesses, and/or conditional branching). For example, an embedded device may have a processor core to control device operation and/or perform tasks of arbitrary complexity/best-effort. This may include, without limitation: a real-time operating system (RTOS), memory management, etc. Typically, such CPUs are selected to have relatively short pipelining, longer words (e.g., 32-bit, 64-bit, and/or super-scalar words), and/or addressable space that can access both local cache memory and bus. More directly, the processor may often switch between tasks, and must account for branch disruption and/or arbitrary memory access.

A digital signal processor (DSP) is optimized specifically for processing digital signals in real-time. Signal processing is high complexity and usually entails many iterations of similar processing over array-based data structures. In other words, DSPs seldom branch and can have deep pipelines of special purpose accelerators. Unlike CPUs, DSPs are selected to have relatively long pipelining, consistent word size, and dedicated memory. DSPs have spawned a variety of other purpose-specific processors such as ISPs and GPUs.

An image signal processor (ISP) performs many of the same tasks repeatedly over a well-defined data structure. Specifically, the ISP maps captured camera sensor data to a color space. ISP operations often include, without limitation: demosaicing, color correction, white balance, and/or autoexposure. Most of these actions may be done with scalar vector-matrix multiplication. Raw image data has a defined size and capture rate (for video) and the ISP operations are performed identically for each pixel; as a result, ISP designs are heavily pipelined (and seldom branch), may incorporate specialized vector-matrix logic, and often rely on reduced addressable space and other task-specific optimizations. ISP designs only need to keep up with the camera sensor output to stay within the real-time budget; thus, ISPs more often benefit from larger register/data structures and do not need parallelization.

Much like the ISP, a graphic processing unit (GPU) is primarily used to modify image data and may be heavily pipelined (seldom branches) and may incorporate specialized vector-matrix logic. Unlike the ISP however, the GPU often performs image processing acceleration for the CPU, thus the GPU may need to operate on multiple images at a time and/or other image processing tasks of arbitrary complexity. In many cases, GPU tasks may be parallelized and/or constrained by real-time budgets. GPU operations may include, without limitation: stabilization, lens corrections (stitching, warping, stretching), image corrections (shading, blending), noise reduction (filtering, etc.). GPUs may have much larger addressable space that can access both local cache memory and/or pages of system virtual memory. Additionally, a GPU may include multiple parallel cores and load balancing logic to e.g., manage power consumption and/or performance.

A hardware codec converts image data to an encoded data for transfer and/or converts encoded data to image data for playback. Much like ISPs, hardware codecs are often designed according to specific use cases and heavily commoditized. Typical hardware codecs are heavily pipelined, may incorporate discrete cosine transform (DCT) logic (which is used by most compression standards), and often have large internal memories to hold multiple frames of video for motion estimation (spatial and/or temporal). As with ISPs, codecs are often bottlenecked by network connectivity and/or processor bandwidth, thus codecs are seldom parallelized and may have specialized data structures (e.g., registers that are a multiple of an image row width, etc.).

Multiple aspects of the techniques described throughout have potential applicability to processor architectures. Many of the processor considerations discussed above focus on pipeline architecture, data structures, data representation, etc.; these architectural differences may also create further opportunities for enhancement when combined with array-based self-similar computations.

In some embodiments, the pipeline of processor logic (e.g., instruction fetch (IF), instruction decode (ID), etc.) may be modified to support specific instructions for array handling and/or arithmetic properties used in self-similar computations. One such instruction may provide conditional bit shift; e.g., an opcode that includes operand fields for one or more of: a number of bits to shift, a data structure (register, immediate, etc.) and/or a condition (e.g., the number of MSBs which are zero, etc.). Any number of variations may be substituted with equal success—e.g., a conditional bit shift of a fixed value, a conditional bit shift left/right, a bit shift of a conditional value, etc.

As another example, the instruction set may support different operations for correction/modification. In one embodiment, an opcode may include operand fields for e.g., correction type, correction precision, and operand. For example, a first opcode instruction may specify correction based on the LSB (passed in via register, immediate, etc.), a second opcode may disable correction, still other opcodes may directly apply a static or LUT-based correction value. In some variants the correction may be calculated via dedicated logic (e.g., a linear interpolation block, etc.), in other embodiments the correction may be obtained as an iterative calculation (e.g., a series expansion, etc.).

In some embodiments, the data structures of the processor logic (e.g., registers, arrays, cache, etc.) may be modified to support array handling and/or element-wise operations useful for self-similar computations. In some variants, a memory may store multiple look-up tables (LUTs) that are characterized by operation and scale. For example, LUTs may be based on different log bases (base 10, base 2, natural log, etc.), monomial operations, tanh, sigmoid, etc. These LUTs may also be of different scales corresponding to different conditional bit shifts (e.g., bit shift of 2, 4, 8, etc.). In addition, some variants may have different LUT sizes depending on processing complexity (e.g., 4-bit, 8-bit, 16-bit, etc.). In some embodiments, an instruction set may also provide specific support for LUT-based computation. As but one such example, an instruction might be used to load a LUT (from memory corresponding to an operation at a scale), and another instruction may be used to retrieve the contents at a LUT address.

In some embodiments, array-based data structures may be coupled to different portions of processor logic. In one embodiment, a first input array may be connected to a first set of logic (e.g., conditional bit shift); the first input array may be coupled to a first operand array (e.g., MSB vector) and one or more additional operand array(s) (e.g., LSB vector). In other embodiments, logical array-based data structures may be substituted with equal success. Here, logical array-based data structures refer to data structures that are implemented within addressing (i.e., locations in memory). Addressing variants may use registers, on-chip cache memory, intermediate addressable memory, and/or any other form of memory structure. Under either physical or logical implementations, one or more operand arrays may be coupled to computational logic and/or memory for either operand; examples may include e.g., LUTs, ALUs, MACs, and/or other forms of combinatorial or sequential logic, etc.

In one embodiment, the processor implements fixed precision logic. Fixed precision logic represents values with a first amount of integer bits, and a second amount of fractional bits. For example, 8-bit fixed precision with 4 bits of integer and 4 bits of fraction can represent the linear range 0 to 15.9375. In some cases, fixed precision may additionally include sign bits or operate according to two's complement. In one embodiment, the processor implements floating precision logic. Floating precision logic represents values with an exponent, mantissa, and sign. In other words, floating precision logic represents values across a flexible range, relative to the decimal point. More generally, artisans of ordinary skill in the related arts will readily appreciate that the techniques described throughout may be extended to any representation of numerical values.

In one embodiment, different elements of the array may be computed via different processing logic, depending on the element's contents (which are determined at runtime). As a brief aside, most compilers make conservative assumptions for an operation at compile time; for example, multiplying two unsigned 8-bit numbers requires 16-bits to represent the full range of products—so, the compiler treats the resulting data type as a 16-bit product. In the context of an array-based data structure, the entire array inherits the conservative assumption. In contrast, embodiments of the present disclosure enable e.g., single instruction multiple data (SIMD) processing. SIMD processors may enable different elements within the same array to have different conditional shift amounts (e.g., the shift is determined by each element at runtime, rather than the compiler at compile time, etc.). For example, elements that have only-zero most significant bits (MSBs) are bit shifted, elements with non-zero MSBs are not. In other words, the processor logic only performs a bit shift when an element meets a specific condition (only-zero MSB). Notably, any data-based modification to the processing logic occur at runtime, not compile time. Instead, the compiler may handle the array as if it had a consistent precision.

Referring back to FIG. 4, unlike the aforementioned processors which focus on optimizing internal pipelining for performance trade-offs, the sparse matrix processor is optimized for highly parallelized thread-based processing. The following discussion provides a specific discussion of the internal operations, design considerations, and/or alternatives, for a sparse processing unit (SPU 900). So-called “machine learning” refers to computing techniques that “learn” to perform specific tasks through observation and inference rather than explicit examples. Neural networks are one type of machine learning techniques. Here, the SPU 900 processor is used to emulate a neural network of logical nodes.

As a brief aside, there are many different types of parallelism that may be leveraged in neural network processing. Data-level parallelism refers to operations that may be performed in parallel over different sets of data. Control path-level parallelism refers to operations that may be separately controlled. Thread-level parallelism spans both data and control path parallelism; for instance, two parallel threads may operate on parallel data streams and/or start and complete independently. Parallelism and its benefits for neural network processing are described within U.S. patent application Ser. No. 17/367,521 filed Jul. 5, 2021, and entitled “METHODS AND APPARATUS FOR THREAD-BASED SCHEDULING IN MULTICORE NEURAL NETWORKS”, previously incorporated by reference in its entirety.

The sparse matrix processor leverages thread-level parallelism and asynchronous handshaking to decouple sub-core-to-sub-core data path dependencies of the neural network. In other words, neural network threads run independently of one another, without any centralized scheduling and/or resource locking (e.g., semaphore signaling, critical path execution, etc.). Decoupling thread dependencies allows sub-cores to execute threads asynchronously. Thread-level parallelism uses packetized communication to avoid physical connectivity issues (e.g., wiring limitations), computational complexity, and/or scheduling overhead.

Translation logic is glue logic that translates the packet protocol natively used by the sub-cores to/from the system bus protocol. A “bus” refers to a shared physical interconnect between components; e.g., a “system bus” is shared between the components of a system. Dedicated busses may be used to decouple communication (e.g., to enable a first portion of the system to operate while other portions are sleeping, busy, and/or otherwise unavailable).

A bus may be associated with a bus protocol that allows the various connected components to arbitrate for access to read/write onto the physical bus. As used herein, the term “packet” refers to a logical unit of data for routing (sometimes via multiple “hops”) through a logical network—e.g., a logical network may span across multiple physical busses. The packet protocol refers to the signaling conventions used to transact and/or distinguish between the elements of a packet (e.g., address, data payload, handshake signaling, etc.).

To translate a packet to a system bus transaction, the translation logic converts the packet protocol information into physical signals according to the bus protocol. For example, the packet address data may be logically converted to address bits corresponding to the system bus (and its associated memory map). Similarly, the data payload may be converted from variable bit widths to the physical bit width of the system bus; this may include concatenating multiple payloads together, splitting payloads apart, and/or padding/deprecating data payloads. Control signaling (read/write) and/or data flow (buffering, ready/acknowledge, etc.) may also be handled by the translation logic.

To convert a system bus transaction to packet data, the process may be logically reversed. In other words, physical system bus data is read from the bus and written into buffers to be packetized. Arbitrarily sized data can be split into multiple buffers and retrieved one at a time or retrieved using “scatter-gather” direct memory access (DMA). “Scatter-gather” refers to the process of gathering data from, or scattering data into, a given set of buffers. The buffered data is then subdivided into data payloads, and addressed to the relevant logical endpoint (e.g., a sub-core of the neural network).

While the present discussion describes a packet protocol and a system bus protocol, the principles described throughout have broad applicability to any communication protocol. For example, some devices may use multiple layers of abstraction to overlay a logical packet protocol onto a physical bus (e.g., Ethernet), such implementations often rely on a communication stack with multiple distinct layers of protocols (e.g., a physical layer for bus arbitration, and a network layer for packet transfer, etc.).

As shown, each sub-core of the neural network includes its own processing hardware, local weights, global weights, working memory, and accumulator. These components may be generally re-purposed for other processing tasks. For example, memory components may be aggregated together to a specified bit width and memory range (e.g., a 1.5 Mb of memory could be re-mapped to an addressable range of 24K with 64 bit words, 48K with 32 bit words, etc.). In other implementations, processing hardware may provide, e.g., combinatorial and/or sequential logic, processing components (e.g., arithmetic logic units (ALUs), multiply-accumulates (MACs), etc.).

The sub-core designs have been optimized for neural network processing, however this optimization may be useful in other ways as well. For example, the highly distributed nature of the sub-cores may be useful to provide RAID-like memory storage (redundant array of independent disks), offering both memory redundancy and robustness. Similarly, the smaller footprint of a sub-core and its associated memory may be easier to floorplan and physically “pepper-in-to” a crowded SoC die compared to a single memory footprint.

As previously noted, each sub-core has its own corresponding router. Data may be read into and/or out of the sub-core using the packet protocol. While straightforward implementations may map a unique network address to each sub-core of the pool, packet protocols allow for a single entity to correspond to multiple logical entities. In other words, some variants may allow a single sub-core to have a first logical address for its processing hardware, a second logical address for its memory, etc.

More directly, artisans of ordinary skill in the related arts given the contents of the present disclosure will readily appreciate that the logical nature of packet-based communication allows for highly flexible logical partitioning. Any sub-core may be logically addressed as (one or more of) a memory sub-core, a neural network sub-core, or a reserved sub-core. Furthermore, the logical addressing is not fixed to the physical device construction and may be changed according to a compile-time, run-time, or even program-time considerations.

The memory 1000 (non-transitory computer-readable medium) may be used to store data. In one embodiment, data may be stored as non-transitory symbols (e.g., bits, bytes, words, and/or other data structures.) In one specific implementation, the memory subsystem is realized as one or more physical memory chips (e.g., NAND/NOR flash) that are logically separated into memory data structures. The memory subsystem may be bifurcated into program code (e.g., a partitioning routine and/or other operational routines) and/or program data (e.g., neural network configurations). In some variants, program code and/or program data may be further organized for dedicated and/or collaborative use. For example, a processor may share a common memory buffer with one or more other peripherals to facilitate large transfers of data.

Program code is implemented as computer-readable instructions that when executed by the processor cause the processor to perform tasks. Examples of such tasks may include: configuration of other logic (e.g., the sparse processing unit (SPU 900) discussed below), memory mapping of the memory resources, and control/articulation of the other peripherals (if present). In some embodiments, the program code may be statically stored within the apparatus as firmware. In other embodiments, the program code may be dynamically stored (and changeable) via software updates. In some such variants, software may be subsequently updated by external parties and/or the user, based on various access permissions and procedures.

The foregoing discussion briefly describes different processor implementations and their relative differences. The control and data subsystem may be implemented with any number and/or type of processors (e.g., CPU-only, DSP-only, CPU-DSP, etc.). Furthermore, processor implementations may multiply, combine, further subdivide, augment, and/or subsume the foregoing functionalities within these or other processing elements.

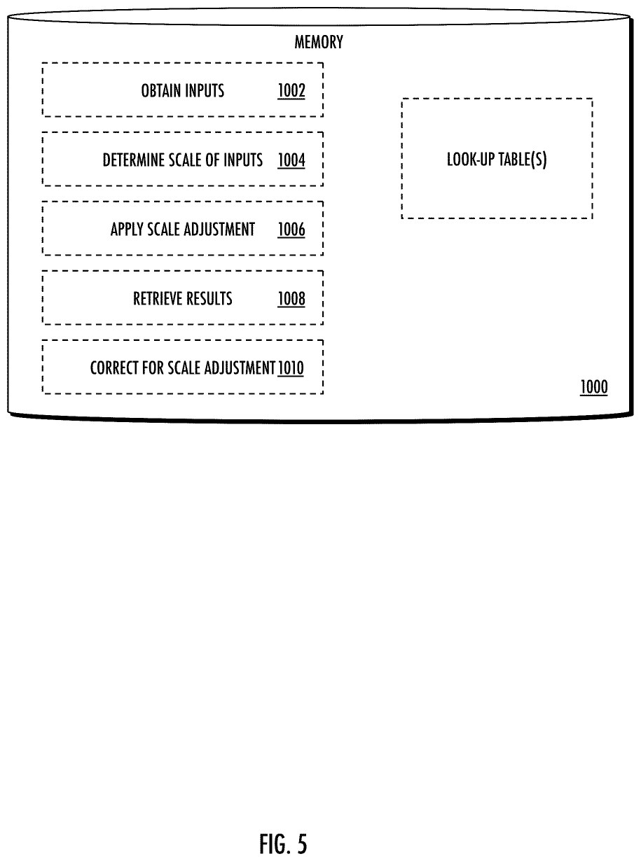

Referring now to FIG. 5, a generalized method for self-similar computation in fixed precision systems is implemented as instructions stored within non-transitory computer-readable medium. In the illustrated implementation, when executed by a processor the instructions are configured to cause the processor to: obtain inputs, determine a scale of inputs, apply a scale adjustment, look-up results, and correct for scale adjustment. Each step of the illustrated method is discussed in greater detail below.

At step 1002, the processor obtains inputs. In one specific embodiment, the input data is an input operand having a first fixed precision. In some implementations, the operands arrive as array-based data structures produced by sensors or prior pipeline stages, such as vectors of audio samples or matrices of image samples. Implementations may flag elements as all-zeros or all-ones for out-of-range handling and may support different source bit-widths while normalizing to the system's fixed precision for subsequent processing.

More generally, inputs may be received, retrieved, derived, or otherwise obtained from memory, network interfaces, or intermediate processing stages. For example, the input operand may be provided by a sensor subsystem as raw data samples; in another example, the operand may be retrieved from stored program data or generated by prior arithmetic logic. In still other cases, the operand may be received as packetized data from an external device. While the previously described embodiments describe 16-bit fixed precision samples, the operand may be encoded in any bit width or format supported by the system, including unsigned or signed fixed precision integers, two's complement representations, or mixed integer-fractional encodings. Still other implementations may calculate, convert or otherwise derive the input operand in fixed precision format; for example, a floating precision, integer, double, or other digital representation of value might be converted into fixed precision format.

As used herein, the term “operand” and its linguistic derivatives, broadly refers to any numerical value, vector, matrix, array, or other data structure used for a processing operation. The operand may originate from a sensor subsystem (e.g., microphone, imaging sensor, inertial sensor), a memory structure (e.g., registers, cache, or stored program data), or an external communication interface (e.g., packetized data over a bus or network). The operand may represent raw samples, intermediate results from earlier stages of a computation, or values generated by other logic units within the system. The input operand provides a unit of data, at fixed precision, that can be partitioned, shifted, and corrected according to the self-similar computation methods described herein.

At step 1004, the processor determines a scale of inputs. In one embodiment, the input operand is split into a first portion and a second portion. For example, a fixed precision value may be split into its most significant bits (MSB) and its least significant bits (LSB). The contents of the first portion and the second portion are assessed for content (e.g., all-zeros, all-ones, some portion of zeros/ones, etc.). The content of the first portion and the second portion may be used to determine the scale of operation. In other words, the processor may classify scale by examining leading bits (e.g., whether a most-significant-bit portion is zero or non-zero) and recording a corresponding shift amount. This classification enables decomposition of the computation into sub-computations that operate at different scales and later re-composition into a fixed-precision result.

More generally, an input operand is classified according to a scale, range, or other characteristic that influences how the operand will be processed under fixed precision constraints. While certain embodiments describe determining scale by evaluating leading bits or detecting an all-zero most-significant portion, other implementations may use arithmetic, logical, statistical, or contextual criteria to select a scale. For example, a processor may assign scale based on the magnitude of the operand relative to a dynamic threshold, based on sensor configuration metadata, or based on a previously recorded history of operand values. In still other cases, the determination may occur implicitly by mapping the operand into a normalized domain such as logarithmic or exponential space. Regardless of the mechanism, the determined classification or indication of scale guides subsequent adjustment, look-up, and correction so that the overall computation remains within fixed precision limits.

At step 1006, the processor applies a scale adjustment. In one embodiment, the scale adjustment is a shift amount based on the determined content. For example, shift logic shifts a least-significant-bit portion into a most-significant-bit position when the most-significant-bit portion is all zeros and records the shift amount for later correction. The shift amount may be fixed, determined per element, or applied in increments, and different elements within the same array may undergo different shift amounts at runtime.

Here, scale adjustment fits a portion of the operand within a range or domain that permits efficient computation under fixed precision limits. While certain embodiments perform conditional bit shifting to normalize the operand magnitude, other forms of adjustment may be substituted with equal success. For example, scale adjustment may include arithmetic normalization, re-quantization into a different fixed precision format, or mapping into a logarithmic, exponential, or polynomial basis. In some variants, adjustment may be adaptive, based on operating conditions such as dynamic range of sensor data, processor word length, or available memory resources. In still other cases, adjustment may be realized implicitly by routing the operand to different look-up tables or function approximators that each assume a different scale.

At step 1008, the processor obtains a result. In one specific implementation, the processor retrieves a pre-computed value from a look-up-table based on the first portion. The fixed precision of the look-up-table may be different than the fixed precision of the input operand; e.g., an input operand of 16 bits might use only 8 bits of MSB to address the LUT, etc. The processor splits the operand into a first portion (e.g., an MSB vector) and a second portion (e.g., an LSB vector) and uses the first portion to index a look-up table storing pre-computed values for the target operation at a lower address range. The split enables use of compact LUTs and supports implementations that select among multiple LUTs by operation and scale.

Conceptually, the reduced precision look-up provides an intermediate result for the self-similar computation without requiring a full-precision calculation. While some embodiments employ a look-up table indexed by a portion of the operand, other forms of retrieval or estimation may be substituted. For example, the processor may obtain approximate values from compressed data structures, polynomial or Taylor series expansions stored in memory, etc.; other multiple sources may be combined, such as a hybrid of direct calculation and look-up, or a hierarchical scheme where coarse values are retrieved from one table and refined with another. In other words, a tractable approximation of the target operation can be obtained at this reduced precision, and corrected or refined in later steps, thereby conserving memory and computation resources while maintaining accuracy within fixed precision limits.

At step 1010, the processor corrects for scale adjustment. In one implementation, the pre-computed value is calculated based on the contents of the LSB, the shift amount, or some combination thereof. The processor corrects for the applied scale adjustment and, where applicable, refines the result using the second portion. For logarithmic operations, the processor may subtract a correction derived from the recorded shift amount using the product rule for logs; when the MSB portion is non-zero, the processor may compute a linear interpolation between adjacent LUT entries using fractional contributions from the LSB portion. For monomial operations, the processor may multiply a LUT-based estimate by a factor derived from the shift amount or interpolate between adjacent entries when the MSB portion is non-zero. Implementations may omit interpolation or substitute other approximation techniques based on accuracy or resource budgets.

The correction reconciles the reduced-precision estimate with the original operand's scale so that the corrected result is accurate within fixed precision constraints. Although some embodiments perform linear interpolation or apply a shift-based offset, other correction mechanisms may be used. For example, correction may involve polynomial or rational approximations, iterative refinement and/or selection among multiple pre-computed bias terms. In certain variants, correction may be performed adaptively, using feedback from downstream processing stages to adjust accuracy versus resource use. In still other cases, correction may be realized by combining outputs from different approximators (e.g., LUT and series expansion), etc. Regardless of implementation, this step attempts to compensate for the lost fidelity of scaling and look-up, ensuring that the output remains consistent with the intended mathematical operation while respecting fixed precision limitations.

In some variants, the processor may handle edge conditions for the fixed-precision result. If an input element is all-zeros or all-ones, the processor substitutes defined constants to represent out-of-range values and may set flags indicating overflow or underflow. In other words, overflow and underflow conditions are outside the capabilities of fixed precision representation; thus, these conditions may be handled in other processes downstream.

The disclosed method of FIG. 5 supports pre-processing and machine learning pipelines. For example, it enables log-mel or related transforms for audio and ISP-related operations for imaging and supplies fixed-precision results for neural-network stages such as norm computations. By decomposing computations across scales and recomposing them within fixed precision, the method reduces LUT size and computation while maintaining compatibility with embedded or low-power pipelines.

More generally, the foregoing method may be realized within hardware, firmware, or software, and may expose instruction-level support for conditional shifts and correction or interpolation operations. Architectures may also execute the steps in SIMD fashion, allowing per-element decisions about shift amounts and correction at runtime within a single array operation.

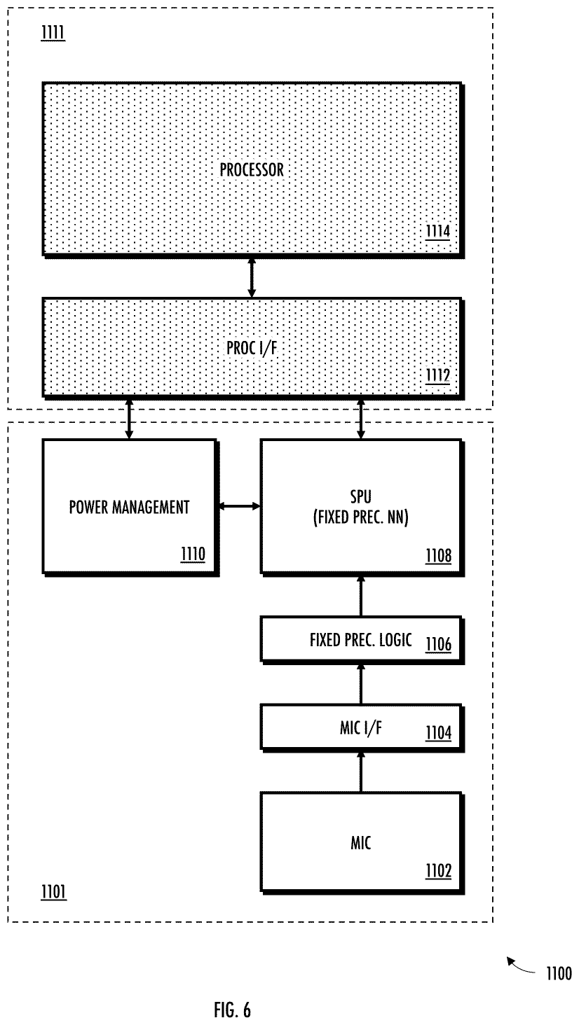

FIG. 6 is a logical block diagram of another apparatus 1100, useful to demonstrate a specific use case that leverages the various principles described herein. The apparatus may incorporate the components of the generalized apparatus described elsewhere (e.g., FIG. 4 and associated discussion). The apparatus 1100 includes a first power domain 1101 and a second power domain 1111. The first power domain 1101 and second power domain 1111 may be independently powered; this enables unique applications such as e.g., “wake word” processing using the SPU 1108 while the host processor 1114 is in low power/sleep modes.

As a brief aside, “wake word” application enables a device to remain in a low-power or sleep state until a predefined keyword is detected, at which point the device transitions to active operation to perform more complex tasks. Conventional speech processing approaches make wake word detection challenging, as they often rely on computationally intensive operations such as noise reduction, speech isolation, and channel estimation. Floating-point neural networks avoid some of these preprocessing steps but impose significant cost in terms of power and silicon area due to floating-point arithmetic. In contrast, the techniques described herein allow fixed precision neural networks to interface directly with microphone inputs, performing feature extraction and inference at low power. This enables wake word processing to be executed continuously within a constrained power domain, while higher-power processing resources remain inactive until needed.

As shown in FIG. 6, the first power domain 1101 includes a microphone 1102, a microphone interface 1104, fixed precision pre-processing logic 1106, a sparse processing unit (SPU 1108), and a power management unit (PMU 1110). The first power domain 1101 is designed to operate in a low-power state (for extended duration and/or continuously), handling initial acoustic capture, quantization, and early-stage feature extraction directly within the fixed precision domain. By directly connecting microphone interface 1104 via the fixed precision pre-processing logic 1106 to the SPU 1108, the apparatus can perform lightweight neural network inference on directly sampled data (using logarithmic or log-mel transforms), without activating the host processor 1114.

The second power domain 1111 includes a processor interface 1112 and a host processor 1114. The second domain may be placed into deep sleep or low-power modes while the first power domain 1101 remains active, thereby reducing overall system power consumption. When certain trigger conditions are met (for example, detection of a “wake word” or classification of a high-priority acoustic event) the first power domain 1101 signals the second power domain 1111 via the power management unit (PMU 1110). The host processor 1114 may then be powered up to perform additional tasks such as higher-order natural language processing, user interaction, or communication with external systems. By separating functionality into independently powered domains, apparatus 1100 provides a flexible architecture that balances responsiveness with power efficiency, supporting continuous sensing use cases such as voice assistants, smart sensors, and other embedded applications.

The following sequence of events illustrates wake word operation. First, the microphone 1102 captures acoustic signals from the environment and converts them into electrical waveforms. The microphone interface 1104 digitizes these waveforms and presents them as fixed precision operands to the fixed precision pre-processing logic 1106. The fixed precision pre-processing logic 1106 implements the self-similar computation methods described herein, such as conditional shifting, reduced-precision look-ups, and correction for scale adjustment, to transform raw audio samples into feature representations (e.g., log-mel coefficients or other compressed forms) that are more suitable for neural network processing. These feature representations are then provided to the sparse processing unit (SPU 1108), which performs inference operations such as keyword detection, pattern recognition, or environmental classification using fixed precision neural network models. When the SPU 1108 determines that a predefined condition is satisfied—for example, detection of a wake word or classification of an acoustic event—it generates a trigger signal to the power management unit (PMU 1110)—this activates the second power domain ii, allowing the host processor 1114 to transition from a low-power state into active operation. The host processor 1114 may then execute higher-level tasks, including speech recognition, user interaction, or network communication. This staged processing flow enables continuous low-power monitoring by the first domain, while reserving the more energy-intensive host processor for event-driven engagement, thereby achieving both responsiveness and efficiency in embedded and battery-constrained applications.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method, comprising:
obtaining an input operand having a first fixed precision;
splitting the input operand into a first portion and a second portion;
determining a shift amount based on the first portion;
retrieving a pre-computed value from a look-up-table based on the first portion, where the pre-computed value has a second fixed precision; and
calculating a result based on the pre-computed value and the second portion or the shift amount.

2. The method of claim 1, where the first fixed precision is 16 bits and the second fixed precision is 8 bits.

3. The method of claim 1, where the first portion comprises a most significant bit vector and the second portion comprises a least significant bit vector.

4. The method of claim 3, where the shift amount is zero when the most significant bit vector is non-zero.

5. The method of claim 4, where the result is based on a linear interpolation of the least significant bit vector.

6. The method of claim 3, where the shift amount is a fixed amount when the most significant bit vector is zero.

7. The method of claim 3, where the result is based on the most significant bit vector and the least significant bit vector being all-zeros or all-ones.

8. The method of claim 1, where the look-up-table comprises a plurality of pre-computed values for a logarithm operation.

9. The method of claim 1, where the look-up-table comprises a plurality of pre-computed values for a monomial expansion operation.

10. An apparatus, comprising:
a conditional shift logic configured to shift a second portion of an input operand based on a first portion of the input operand, where the input operand has a first fixed precision;
a look-up-table configured to retrieve pre-computed values for a self-similar computation at a second fixed precision that is less than the first fixed precision; and
an arithmetic logic unit configured to modify a first pre-computed value to generate a result value having the first fixed precision.

11. The apparatus of claim 10, further comprising a sensor configured to provide sensed data via the input operand according to the first fixed precision and where the self-similar computation comprises a logarithm.

12. The apparatus of claim 10, further comprising a neural network logic configured to perform a norm function via the input operand according to the first fixed precision and where the self-similar computation comprises a monomial expansion.

13. The apparatus of claim 10, further comprising a linear interpolator configured to calculate a linear approximation based on a third fixed precision that is less than the first fixed precision.

14. The apparatus of claim 10, where the conditional shift logic is configured to shift the second portion of the input operand based on a number of zeros within the first portion of the input operand.

15. The apparatus of claim 10, where the conditional shift logic is configured to shift the second portion of the input operand a fixed amount based on the first portion of the input operand being all-zeros.

16. A system, comprising:
a fixed precision logic configured to compute fixed precision results from fixed precision operands, where the fixed precision logic comprises a conditional shift logic, a look-up-table, and an arithmetic logic unit;
a fixed precision neural network configured to receive the fixed precision results from the fixed precision logic; and
a processor configured to receive packet data from the fixed precision neural network.

17. The system of claim 16, where the system further comprises a fixed precision sensor configured to represent sensed data with the fixed precision operands.

18. The system of claim 17, where the fixed precision sensor comprises a microphone that senses acoustic waves.

19. The system of claim 17, where the fixed precision sensor comprises an imaging sensor that senses light intensity.

20. The system of claim 16, where the fixed precision results are used for norm operations of the fixed precision neural network.
